(19) United States
(12) Patent Application Publication
(10) Pub. No.: US 2007/0119083 A1
(43) Pub. Date: May 31, 2007

(54) Sign holder

(76) Inventor: Danielle N. Diller, Indianapolis, IN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/289,098

(22) Filed: Nov. 29, 2005

(51) Int. Cl. G09F 3/18

(52) U.S. Cl. 40/661

(57) ABSTRACT

The present invention provides a sign holder including a front panel and rear panel, the two panels each having at least one opening therein. At least one fastener and coupling are also provided, the fastener being adapted to be inserted through the openings in the two panels and the coupling being adapted to adjustably, threadably engage the fastener. By use of this fastener and coupling arrangement, the front and rear panels are securely held to one another such that a sign may be contained therebetween. It is preferred that the coupling further serve to maintain the sign holder in an upright position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The present invention is directed generally to sign or picture holders, and more specifically to versatile, self-supporting sign or picture holders that can be reused with various media removably associated therewith.

Signs are ubiquitous in modern society. They are used to provide directions, for product or business recognition, or, in ever-increasing fashion, for marketing. Individuals and businesses routinely use signs to display information about themselves, their products and services, special promotions, sales, and the like. Further, during special events, such as seminars, meetings, and the like, whether held by businesses or other individuals or entities, placement of signs throughout the location of the event can provide attendees with directions, scheduling information, sponsorship information, or any manner of information a sponsor of an event wishes to communicate.

Whatever the use or purpose of a given sign, the content of such signs may change rapidly, and the need to move signs from one location to another, displaying new or different content at each location, is great. Fixed signs do not, by their very nature, allow for portability. Pre-made signs are not readily modified for use in displaying various materials or information, and may require fastening to some solid support or surface upon relocation from one place to another. Sign holders are known, such as frames, stands and the like, that can provide support for various signs as they are moved from one location to the next, but such sign holders are often bulky and lack versatility in the types, sizes, and orientation of materials that can be displayed therewith.

The present invention provides portable, reusable sign holders that are adapted for use with a variety of types, sizes, thickness, and orientation of materials. The sign holders of the present invention are also sturdy, self-supporting, and protective of the media contained therein.

### BRIEF SUMMARY OF THE INVENTION

The present invention provides a sign holder including a front panel and rear panel, the two panels each having at least one opening therein. At least one fastener and coupling are also provided, the fastener being adapted to be inserted through the openings in the two panels and the coupling being adapted to engage the fastener. By use of this fastener and coupling arrangement, the front and rear panels are securely held to one another such that a sign may be contained therebetween. It is preferred that the coupling further serve to maintain the sign holder in an upright position.

In a preferred embodiment of the present invention, the sign holder is substantially rectangular in shape with an opening located substantially in each corner of each of the front and rear panels. Four fastener and coupling pairs are used to securely attach the front panel to the rear panel, and to securely hold a sign therebetween.

A sign holder of the present invention may further include a beveled edge along a perimeter of front panel.

In one alternative embodiment of the present invention, the front and rear panels of the invention are provided in a concave shape. In another alternative embodiment of the present invention, the front and rear panels are provided in a convex shape.

In still another embodiment of the present invention, the front panel is fixedly attached to a frame that extends around a perimeter thereof. In this embodiment of the present invention, openings are present in the frame such that a fastener and coupling configuration can be used to securely, removably attach the frame and front panel combination to the rear panel.

### BRIEF DESCRIPTION OF THE DRAWINGS

FIG. 1 is a perspective view of one embodiment of a sign holder constructed in accordance with the teachings of the present invention.

FIG. 2 is an exploded view of the sign holder of FIG. 1.

FIG. 3 is a top view of the sign holder of FIG. 1.

FIG. 4 is a right, side elevational view of the sign holder of FIG. 1.

FIG. 5 is a bottom view of the sign holder of FIG. 1.

FIG. 6 is a front view of the sign holder of FIG. 1.

FIG. 7 is a perspective view of an alternative embodiment of a sign holder constructed in accordance with the teachings of the present invention, the sign holder having a substantially concave shape.

FIG. 8 is a perspective view of another alternative embodiment of a sign holder constructed in accordance with the teachings of the present invention, the sign holder having a frame around a perimeter of the front panel thereof.

### DETAILED DESCRIPTION OF THE INVENTION

Turning now to the drawings, wherein like numerals represent like parts, the numeral 10 refers generally to a sign holder constructed in accordance with the teachings of the present invention. Sign holder 10 includes a front panel 12, a rear panel 14, upper fasteners 16, upper couplings 18, lower fasteners 20, and lower couplings 22.

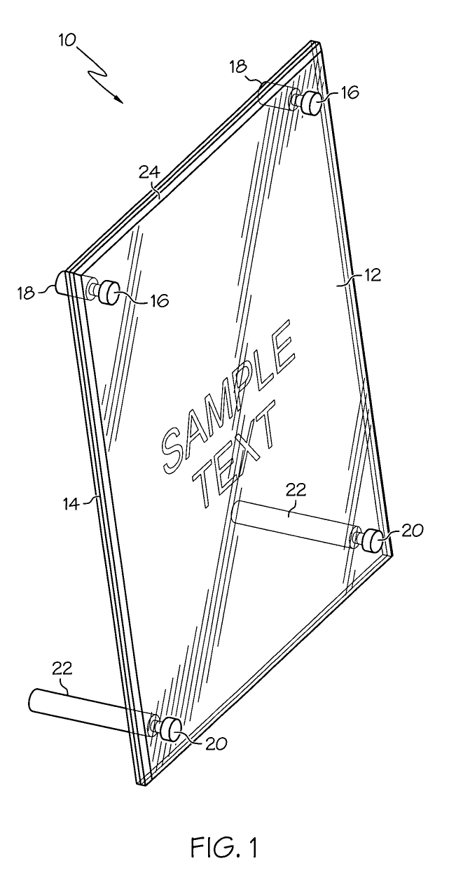

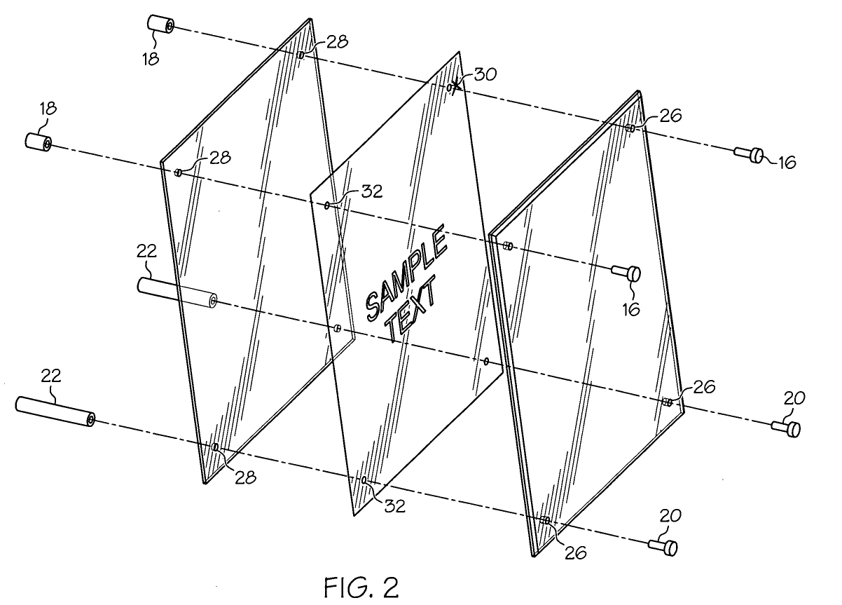

Front panel 12 is preferably constructed from a durable, transparent material such as acrylic, polyvinyl chloride (PVC), polyethylene terephthalate (PET), polystyrene, methylacrylate acrylonitrile butadiene styrene copolymer (MABS), polymethyl methacrylate, polypropylene, high density polyethylene, polycarbonate, and the like, or some combination of such polymers or copolymers. Front panel 12 may also be constructed from glass or any other suitable material known in the art or hereafter discovered. Front panel 12 is preferably constructed of a durable material such that the contents of sign holder 10 are protected from the elements and from physical damage. The material from which front panel 12 is constructed may also be chosen to shield the contents of sign holder 10 from the effects of UV or other radiation. As shown in FIG. 1, front panel 12 includes a beveled edge 24 along a perimeter thereof. Beveled edge 24 may be provided, and may be transparent, as with the rest of front panel 12, or may be provided with coloration or a decorative pattern in order to further enhance the aesthetics of sign holder 10. Front panel 12 also includes a plurality of openings 26, best seen in FIG. 2, by which front panel 12 may be secured to rear panel 14.

Rear panel 14 is preferably constructed from the same material as front panel 12, though any suitable material may be used. Further, though rear panel 14 is preferably transparent in the same manner as front panel 12, it is contemplated that rear panel 14 may be constructed from an opaque material, or may be provided with coloration or decorative design since a sign placed within sign holder 10 need not be viewable through rear panel 14. As shown in FIG. 1, rear panel 14 does not include a beveled edge such as that of front panel 12. Rear panel 14 may, however, include such a beveled edge, and if included, the beveled edge may be provided with coloration, decorative design, and the like. Like front panel 12, rear panel 14 preferably includes a plurality of openings 28, and it is preferred that openings 28 on rear panel 14 align substantially with openings 26 on front panel 12 so that rear panel 14 and front panel 12 may be secured to one another via these openings. Although both front panel 12 and rear panel 14 are shown as being planar, in other embodiments of the present invention these panels may be substantially concave or convex, as described below.

A sign 30 may be positioned between front panel 12 and rear panel 14, as best shown in FIG. 2. Sign 30 may be constructed of any suitable material, such as paper, synthetic polymers, and the like. Because of the mechanism by which front panel 12 is secured to rear panel 14, as described below, sign 30 may also be of varying thickness. If sign 30 is relatively thin, for example, the extent to which upper and lower fasteners 16 and 20 and upper and lower couplings 18 and 22 are engaged will differ from the circumstance in which sign 30 is relatively thick. Thus, varying thicknesses of signs 30 can be accommodated by the present device simply by adjusting upper and lower fasteners 16 and 20. Further, sign 30 may be sized such that it covers substantially the entire surface area of front panel 12 and rear panel 14, in which case sign 30 preferably includes openings 32, which align substantially with openings 26 and 28 in front panel 12 and rear panel 14, respectively, or sign 30 may be of any size or shape that is capable of being secured between front panel 12 and rear panel 14, and therefore of being displayed within sign holder 10. Sign 30 may include a wide range of content, including, but not limited to, images, designs, photographs, text, or combinations thereof. The fasteners of the present invention are preferably screws, as shown in the drawings, and the couplings are preferably threaded to engage the screws. It is contemplated, however, that any suitable fastener may be used, including but not limited to, knobs, anchors, bolts, pins, dowels, rivets, nails, pegs, and the like. Further, it is contemplated that any suitable coupling may be used that is adapted to engage a specific fastener. It is further preferred that the fastener and coupling are adjustably engaged such that sign holder 10 may be used with signs or pictures having a variety of thicknesses, but it is contemplated that a fastener and coupling that are not adjustably engaged, and thus are more limiting with respect to variations in sign or picture thickness, may also be used.

In the embodiment of the present invention shown in the Figures, front panel 12 and rear panel 14 are secured to one another by use of upper fasteners 16, which are threadably engaged with upper couplings 18, and lower fasteners 20, which are threadably engaged with lower couplings 22. As best shown in FIG. 2, at least a portion of upper fasteners 16 are inserted through two of apertures 26 of front panel 12, through sign 30 if sign 30 is of sufficient size or positioned such that an opening 32 in sign 30 is adjacent openings 26, and through openings 28 of rear panel 14. Upper couplings 18 are then threadably engaged with upper fasteners 16, securing front panel 12 firmly to rear panel 14, with sign 30 positioned therebetween.

Likewise, at least a portion of lower fasteners 20, are inserted through two of apertures 26 of front panel 12, through sign 30 if appropriate as described above, and through openings 28 of rear panel 14. Lower couplings 22 are then engaged with lower fasteners 20, securing front panel 12 firmly to rear panel 14. Though upper fasteners 16, lower fasteners 20, upper couplings 18, and lower couplings 20 are shown in the Figures, it is contemplated that any suitable method of removably securing front panel 12 to rear panel 14 may be used.

In addition to receiving lower fasteners 20 and thereby securing front panel 12 to rear panel 14, lower couplings 22 also serve to provide a support for sign holder 10 such that it is maintained in a upright position. As best shown in FIG. 1, in a preferred embodiment, lower couplings 22 are longer than upper couplings 18, having a sufficient length such that sign holder 10 may be placed on a table, counter, or other surface and maintained in an upright position. As noted above, the fastener and coupling method of securing front panel 12 to rear panel 14 described herein may be replaced by any suitable method of securing the two panels. Whatever method is used to secure front panel 12 to rear panel 14, however, it is preferred that method also provide stability to sign holder 10 such that it can be maintained in an upright position similar to that shown in FIG. 1. This is not true of embodiments of the present invention that are adapted to hang on a wall, as described further below.

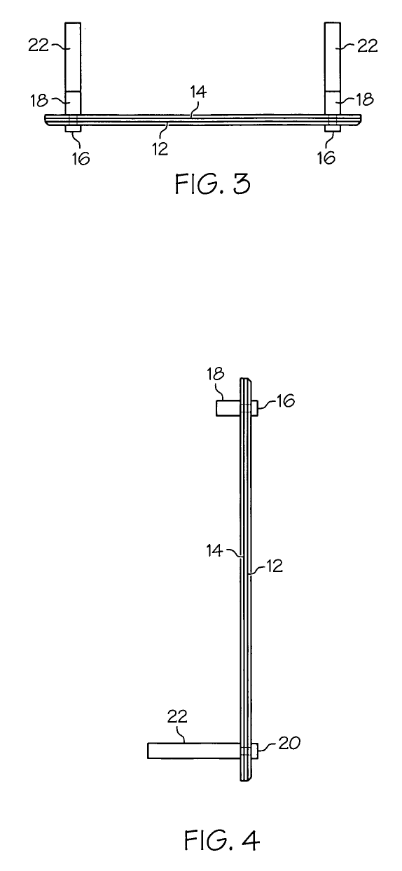

FIG. 3 provides a top view of a sign holder 10, as shown in FIG. 1, with upper fasteners 16 fully tightened such that front panel 12 and rear panel 14 are securely held between upper fasteners 16 and upper couplings 18. Lower fasteners 20 are not visible in the drawings, however lower couplings 22 are visible even though they lie in the same vertical planes are upper couplings 18 because lower couplings 22 are longer than upper couplings 18, being of sufficient length to provide support for sign holder 10 such that it is maintained in an upright position. It is not necessary, however, that upper and lower couplings 18 and 22, or upper and lower fasteners 16 and 20, lie in the same vertical planes. The fasteners and couplings of the present invention may be positioned in any suitable manner.

FIG. 4 provides a right side view of a sign holder 10, as shown in FIG. 1, with upper fasteners 16 and lower fasteners 20 fully tightened. Only one of each of upper fasteners 16, upper couplings 18, lower fasteners 20, and lower couplings 22 is visible in the figure because each pair of upper and lower fasteners and couplings lie in the same horizontal plane. It is not necessary that upper fasteners and couplings 16 and 18 lie in the same horizontal plane, however it is preferred that lower fasteners and couplings 20 and 22 do lie in the same horizontal plane in order to provide stability to sign holder 10 when sign holder 10 is in an upright position.

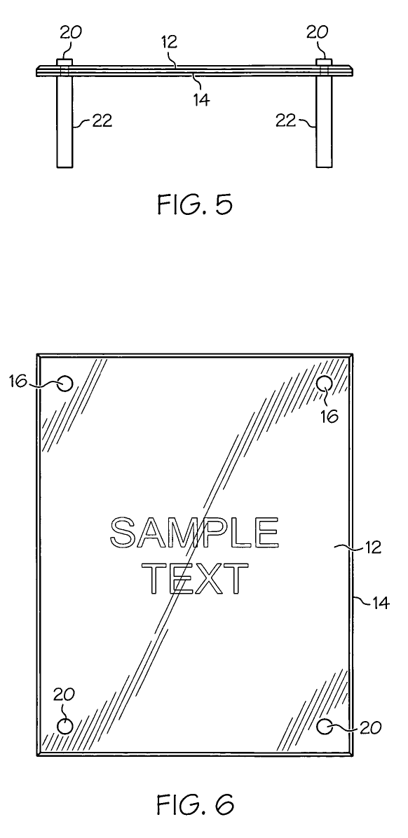

FIG. 5 provides a bottom view of a sign holder 10, as shown in FIG. 1, with lower fasteners 20 fully tightened. Again, front panel 12 and rear panel 14 are visible and held securely to one another. Lower fasteners and couplings 20 and 22 are aligned in a vertical plane with upper fasteners and couplings 16 and 18, as described with respect to FIG. 3, above, though this alignment may be altered without departing from the scope of the present invention.

FIG. 6 provides a front view of a sign holder 10, as shown in FIG. 1. Upper fasteners 16 and lower fasteners 20 are visible, as is beveled edge 24 of front panel 12. Text provided in the image represents the text of a sign contained within sign holder 10, held between front panel 12 and rear panel 14 (not shown).

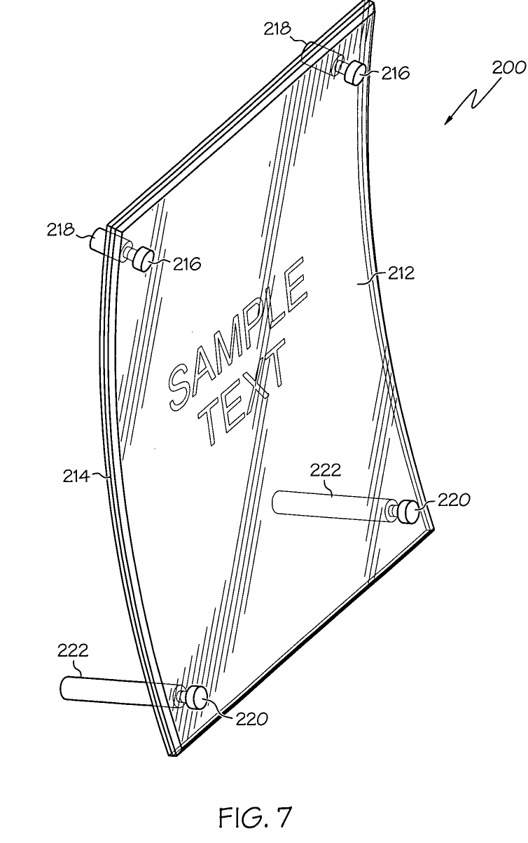

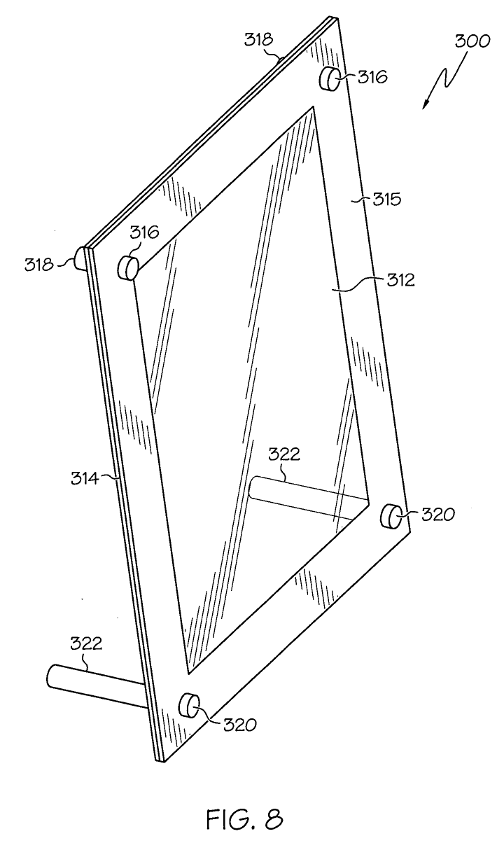

One alternative embodiment of a sign holder constructed in accordance with the teachings of the present invention is provided in FIG. 7. As seen in the Figure, sign holder 200 includes upper fasteners 216, upper couplings 218, lower fasteners 220, lower couplings 222, a front panel 212, and a rear panel 214. The securing of front panel 212 to rear panel 214, and the placement of a sign therebetween, is substantially the same as that described with respect to the embodiment of the present invention shown in FIG. 1, above. In the embodiment of the present device shown in FIG. 7, however, front panel 212 and rear panel 214 are provided in a slightly concave configuration. Such a configuration provides an aesthetic appeal separate from that of the embodiment of the present device shown in FIG. 1. Further, depending on the content of a sign contained within sign holder 200, and the specific lighting thereof, as well as other environmental factors, an effect not attainable with other embodiments of the present device may be achieved. It is contemplated that a sign holder constructed in accordance with the teachings of the present invention may have a greater or lesser degree of concavity than that shown in FIG. 7, or may instead be provided in a convex configuration, depending on the specific use to which sign holder 200 is put and the desired effect thereof.

Another alternative embodiment of the present device is provided in FIG. 8. Sign holder 300 is provided, having upper fasteners 316, upper couplings 318, lower fasteners 320, and lower couplings 322. Front panel 312 and rear panel 314 are also provided. Front panel 312 does not, however, include a beveled edge. Rather, a frame 315 is provided along the perimeter of front panel 312. Frame 315 may be constructed or metal, wood, glass, synthetic polymer, as described with respect to front and rear panels 12 and 14, above, combinations thereof, or any other suitable material. Frame 315 may be provided with coloration or other decorative effects in order to provide a desired aesthetic (e.g. elegant, professional, and the like) to sign holder 300. Alternatively, frame 315 may be constructed from the same material as front panel 312, or may even be an integral portion thereof, and may be provided with scoring, texturing, or other decorative effects in order to achieve a desired aesthetic. Sign holder 300 includes openings (not shown) in frame 315 and rear panel 314 such that fasteners 316 and 320 may pass therethrough in order to engage couplings 318 and 320, thereby securing front panel 312 and frame 315 to rear panel 314.

Each of the embodiments of the present invention described above benefits from the fact that the upper and lower fasteners, and upper and lower couplings, provided therewith may be completely separated from one another, thereby allowing the device to be taken apart for ease of placement and positioning of a sign therein. Further, by simple rearrangement of the positions of one of upper couplings 18 and lower couplings 22, for example, the orientation of sign holder 10 may be changed. Such a rearrangement of an upper coupling 18 and a lower coupling 22 of sign holder 10, for example, results in a sign holder that may be stably sustained in an upright position with a longitudinal axis thereof oriented in a horizontal direction rather than in a vertical direction as shown in the drawings. Thus, signs having that orientation are easily displayed within the same sign holder 10 as signs having a longitudinal axis oriented in a vertical direction by a simple change of position of two couplings before substituting one sign for another. The result is a versatile sign holder.

In yet a further embodiment of the present invention, upper couplings 18 and lower couplings 22 may be provided equal in length (preferably a shorter length, as of upper couplings 18) such that a sign holder of the present invention may be mounted on a wall. In such an embodiment of the present invention, upper and lower couplings 18 and 22 serve not only to engage upper and lower fasteners 16 and 20, but also serve as spacers to set the sign holder a preferred distance from the surface of the wall. Any known method of securing a picture, frame, sign, or other device to a wall may be provided with the sign holder and used to secure the sign holder to a wall. Alternatively, the rear panel of a sign holder to be mounted on a wall may be positioned flush with the surface of the wall, with upper and lowers fasteners 16 and 20 engaging the wall directly and securing the sign holder thereto.

Although the embodiments of the present invention described above and shown in the Figures each include four openings located substantially at each corner of a rectangular sign holder 10, it is contemplated that the number and location of such openings may be varied, as may the overall shape of sign 10, without departing from the scope of the present invention. For example, even with respect to a sign holder 10 such as that shown in FIG. 1, a single opening may be located near the top center of each of front panel 12 and rear panel 14, with a single opening at the bottom center of each panel, for a total of two openings, or with two openings located at the bottom of each panel, one located substantially at each corner, for a total of three openings. Any number and location of openings may be used so long as sign holder 10 is able to securely hold a sign 30 between front panel 12 and rear panel 14. Further, sign holder 10 may be provided in various shapes, such as in the form of a circle, oval, or triangle, or in ornamental shapes such as, for example, a star. In embodiments having only one opening near the bottom of the sign holder, a lower coupling may be used having a “T” or “L” shape, or any other shape or configuration that will allow a single coupling to stably maintain the sign holder in an upright position.

In addition to the various materials that may be used in the construction of front panel 12 and rear panel 14, as described above, upper and lower fasteners 16 and 18, and upper and lower couplings 18 and 20, may also be constructed from a variety of materials. In the embodiments of the present invention shown in the Figures, the various fasteners and couplings used therewith are preferably constructed from metal, such as steel, aluminum, chrome, and the like. Alternatively, however, the various fasteners and couplings used in conjunction with the present device may be constructed of plastic or other polymers (including the same materials used in the construction of front panel 12 and rear panel 14), wood, or any other suitable material.

In addition to placing a sign 30 within sign holder 10, it is further contemplated that matting made, for example, from cardboard, fabric, or other material, may be secured between front panel 12 and rear panel 14 of sign holder 10 in order to provide a decorative effect thereto or to provide support for signs that are of unusual shape or substantially smaller than the size of front panel 12 and rear panel 14. This provides not only an increased aesthetic effect to sign holder 10, but also provides increased stability and support for signs that, due to size or shape, are not readily retained or held in position between front panel 12 and rear panel 14 due to the securing of those panels alone.

### EXAMPLE

A sign holder 200 as shown in FIG. 7 was constructed from two curved acrylic panels, front panel 212 and rear panel 214. Front panel 212 had a thickness of 2.00 mm, while rear panel 214 has a thickness of 3.00 mm. Front panel 212 further included a beveled edge around the perimeter thereof, the beveled edge being provided with a green colorant. Openings were located substantially in each of the four corners of both front panel 212 and rear panel 214 such that the openings in front panel 212 aligned with those of rear panel 214 when the two panels were placed adjacent one another with their edges flush. Upper and lower fasteners 216 and 220 (which are knobbed screws in the embodiment of the present invention provided in this example), and upper and lower couplings 218 and 222 were constructed from stainless steel, with the couplings adapted to threadably engage the fasteners. As shown in FIG. 7, the couplings were provided in substantially cylindrical form, each having flat ends. Upper couplings 218 were each ¾ inches in length, whereas lower couplings 222 were each 3 inches in length.

Although numerous advantages and characteristics of the present invention have been described herein, together with details concerning the structure and function of the invention, the foregoing description is exemplary only. Accordingly, changes may be made in detail, particularly in matters of shape, size, arrangement of features, and materials of the present invention while still remaining within the broad spirit and scope of the invention. It is intended that the scope of the invention be limited only by the claims that follow.

What is claimed is:

1. A sign holder comprising:
a front panel having at least one opening therein;
a rear panel having at least one opening therein;
at least one fastener, at least a portion of said fastener adapted to be inserted through the at least one opening of said front panel and the at least one opening of said second panel; and
at least one coupling adapted to engage said at least one fastener such that said front panel and said rear panel are held securely together.

2. The sign holder of claim 1 wherein said front panel comprises a beveled edge along a perimeter thereof.

3. The sign holder of claim 1 wherein said front panel and said rear panel are constructed from a material selected from the group consisting of plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

4. The sign holder of claim 1 wherein said at least one coupling is constructed from a material selected from the group consisting of metal, wood, plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

5. The sign holder of claim 1 wherein said front panel and said rear panel have a substantially concave shape.

6. The sign holder of claim 1 wherein said front panel and said rear panel have a substantially convex shape.

7. A sign holder comprising:
a front panel, said front panel having at least one upper opening and at least two lower openings;
a rear panel, said rear panel having at least one upper opening and at least two lower openings;
at least one upper fastener, at least a portion of said fastener adapted to be inserted through the at least one opening of said front panel and the at least one opening of said rear panel;
at least two lower fasteners, at least of portion of said lower fasteners adapted to be inserted through the at least two openings of said front panel and the at least two openings of said rear panel;
at least one upper coupling adapted to adjustably engage said at least one upper fastener; and
at least two lower couplings adapted to adjustably engage said at least two lower fasteners, said lower couplings further adapted to maintain the sign holder in an upright position.

8. The sign holder of claim 7 wherein said front panel comprises a beveled edge along a perimeter thereof.

9. The sign holder of claim 7 wherein said front panel and said rear panel are constructed from a material selected from the group consisting of plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

10. The sign holder of claim 7 wherein said at least one upper coupling and said at least two lower couplings are constructed from a material selected from the group consisting of metal, wood, plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

11. The sign holder of claim 7 wherein said front panel and said rear panel have a substantially concave shape.

12. The sign holder of claim 7 wherein said front panel and said rear panel have a substantially convex shape.

13. A sign holder comprising:
a front panel having a perimeter;
a frame portion extending along the perimeter of said front portion and fixedly attached thereto, said frame portion having at least one opening therein;
a rear panel having at least one opening therein;
at least one fastener, at least a portion of said fastener adapted to be inserted through the at least one opening of said frame portion and the at least one opening of said second panel; and
at least one coupling adapted to adjustably engage said at least one fastener such that said front panel and said frame portion are securely held to said rear panel, said coupling further adapted to maintain the sign holder in an upright position.

14. The sign holder of claim 13 wherein said front panel and said rear panel are constructed from a material selected from the group consisting of plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

15. The sign holder of claim 13 wherein said at least one coupling is constructed from a material selected from the group consisting of metal, wood, plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

16. The sign holder of claim 13 wherein said frame portion is constructed from a material selected from the group consisting of metal, wood, plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

17. The sign holder of claim 13 wherein said front panel, said frame portion, and said rear panel have a substantially concave shape.

18. The sign holder of claim 13 wherein said front panel, said frame portion, and said rear panel have a substantially convex shape.

19. A sign holder comprising:
a front panel, said front panel having a substantially rectangular shape and having a plurality of openings therein, wherein at least one of said plurality of openings in said front panel is located substantially in each corner of said front panel;
a rear panel, said rear panel having a substantially rectangular shape and having a plurality of openings therein, the openings in said rear panel capable of being aligned with the openings in said front panel;
a first upper fastener, at least a portion of said first upper fastener being adapted to be inserted through one of said plurality of openings in said front panel and one of said plurality of openings in said rear panel;
a second upper fastener, at least a portion of said second upper fastener being adapted to be inserted through one of said at least plurality of openings in said front panel and one of said plurality of openings in said rear panel;
a first lower fastener, at least a portion of said first lower fastener being adapted to be inserted through one of said plurality of openings in said front panel and one of said plurality of openings in said rear panel;
a second lower fastener, at least a portion of said second lower fastener being adapted to be inserted through one of said plurality of openings in said front panel and one of said plurality of openings in said rear panel;
a first upper coupling, said first upper coupling adapted to adjustably engage said first upper fastener;
a second upper coupling, said second upper coupling adapted to adjustably engage said second upper fastener;
a first lower coupling, said first lower coupling adapted to adjustably engage said first lower fastener; and
a second lower coupling, said second lower coupling adapted to adjustably engage said second lower fastener;
wherein said first and second lower couplings are of greater length than said first and second upper couplings, and further wherein said first and second lower couplings are adapted to maintain the sign holder in an upright position.

20. The sign holder of claim 19 wherein said front panel comprises a beveled edge along a perimeter thereof.

21. The sign holder of claim 19 wherein said front panel and said rear panel are constructed from a material selected from the group consisting of plastic, glass, acrylic, polyvinyl chloride, polyethylene, polyethylene terephthalate, polystyrene, methylacrylate acrylonitrile butadiene styrene copolymer, polycarbonate, polypropylene, and combinations thereof.

22. The sign holder of claim 19 wherein said front panel and said rear panel have a substantially concave shape.

23. The sign holder of claim 19 wherein said front panel and said rear panel have a substantially convex shape.

24. The sign holder of claim 1 wherein said coupling is adapted to maintain the sign holder in an upright position.

25. The sign holder of claim 1 wherein said coupling is further adapted to adjustably engage said at least one fastener.
